(19) United States
(12) Patent Application Publication
(10) Pub. No.: US 2007/0038434 A1
(43) Pub. Date: Feb. 15, 2007

(54) UNIVERSAL SYSTEM INTERFACE

(76) Inventor: Jonatan Cvetko, Harbor City, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/536,333

(22) Filed: Sep. 28, 2006

Related U.S. Application Data
(63) Continuation-in-part of application No. 11/029,312, filed on Jan. 5, 2005.
(60) Provisional application No. 60/731,943, filed on Oct. 31, 2005.

(51) Int. Cl. G06F 9/455

(52) U.S. Cl. 703/23

(57) ABSTRACT

A vehicular system including a vehicle mounted electronic device including user and device interfaces, an electronic media storage device including user and device physical interfaces and a signal processor. In combination the signal processor is operationally situated between the vehicle mounted electronic device and the electronic media storage device. The devices are interconnected and the vehicle mounted electronic device is configured to display at least a portion of the electronic media storage device user interface data and emulate a portion of the electronic media storage device functionality.

### RELATED APPLICATIONS

This application claims priority from provisional patent application Ser. No. 60/731,943 filed Oct. 31, 2005 and is Continuation in Part of non-provisional utility patent application Ser. No. 11/029,312 filed Jan. 5, 2005, both of which are hereby incorporated by reference for all that they disclose.

### BACKGROUND OF THE INVENTION

1. Field of the Invention

The invention relates in general to methods and devices for system interfaces and, more particularly, embodiments of the present invention relate to vehicle mounted electronic system interfaces.

2. Description of the Prior Art

There is a need for a single system that allows functionality to be transferred from an electronic device, such as an MP3 player, and also allows for a user to select from multiple different devices and have each seamlessly interface with a resident electronic device in a vehicle. Existing system interfaces are not without their shortcomings. A major shortcoming of typical vehicle system interface is its lack of flexibility vis-a-vis different systems. For instance, existing systems might allow a user to use a Zune® or iPod® brand media storage music system in a car but such systems would not allow the user to use a competing media storage system.

Music players, especially digital music players, MP3, that provide selective listening to downloaded audio material on the music player are sometimes provided with a cradle or a docking system to hold them upright. However, these cradles are often not designed for vehicles where drivers and passengers have a need, especially on long distance driving, to operate these players. Other portable devices do not even have docking system. Some docking systems for the music/media players are weighted to keep the music players in place. Others are fastened with suction cups, adhesives, adhesive tapes, or screws. It is therefore an object of this invention to provide a cradle that would not have unsightly cords.

As indicated above, lack of universality is problematic for a number of reasons, most notable is the users need to acquire and keep available for use many competing devices. The devices can be both costly and more importantly cumbersome and difficult to maintain and use in an environment where space and convenience are at a premium. In response to such pressures, industry has made a number of attempts to resolve the problem. One popular solution relies on a wireless transmitter to transmit from the device directly to a car radio. Elegant in its simplicity and inexpensive to design and build the transmitters lack the ability to transmit with sound quality that is equivalent to the wired system and do not allow a user to access the functionality of the device, such as changing tracks, or selecting titles from a playlist.

Therefore, there is a need for a single system that allows functionality to be transferred from an electronic device, such as an MP3 player, and also allows for a user to select from multiple different devices and have each seamlessly interface with a resident electronic device in a vehicle.

### BRIEF SUMMARY OF THE INVENTION

The present invention provides a single system that allows functionality to be transferred from a variety of electronic devices, such as an MP3 player, to an electronic device in a vehicle, home, or business such as a radio or TV. The present invention has been developed in response to the current state of the art, and in particular, in response to the aforementioned problems and other problems and needs that have not been fully or completely solved by currently available systems. Thus, it is an overall object of the present invention to effectively resolve at least the problems and shortcomings identified herein. In particular, it is an object of the present invention to provide a system that will provide a system which allows a user switch between electronic devices and/or allow user functionality on the electronic devices to be accessible to a user via an electronic device resident in the vehicle or a home. One embodiment of the present invention provides a single system that allows multiple devices to seamlessly interface with a resident electronic device in a vehicle or home. It is also an object of the present invention to provide a system that will allow a user to dock entertainment, navigational, diagnostic, and monitoring systems in a single port, with complete transparency to the user.

A preferred embodiment of the present invention includes a kit for electronically integrating a specific handheld electronic device with a specific vehicle device or home device. The vehicle device includes a proprietary region called the “head.” One embodiment of the present invention allows for connection to the head. By way of clarification, the term handheld electronic device is intended to be inclusive of portable music libraries, such as those sold under the trademarks Zune® and iPod®, also optionally contemplated are personal digital assistants, or PDAs such as those marketed by Research In Motion under the name Blackberry®. The present invention is not to be limited to the foregoing; rather the foregoing is provided by way of example, with the intent to aid the reader in understanding the invention. In accomplishing the integration objective of the present invention a docking member which includes circuitry is adapted to physically hold a handheld electronic device. The circuit is suitable for converting electronic signals between a device format that is specific to the handheld electronic device and a standard format. The present invention is applicable and useful in home, business, and office. While the term “vehicle” is frequently used herein, the invention is equally useful in the home or business. It is worth noting that “standard” is a term, it is not intended to necessarily convey a particular standard. The circuit is able to communicate with the handheld electronic device using the device format, and another circuit, referred to as a cable circuit, is adapted to convert signals between a head format that is specific to a specific head and the standard format. This cable circuit is in communication with the specific head using the head format, and both circuits are adapted to communicate with one another using the standard format. In this embodiment, the docking member and cable circuits may communicate over a physical cable or communicate wirelessly. The cradle of one embodiment of the invention is applicable to portable devices such as personal digital assistants, global positioning system devices, cell phones, digital videodisk monitors, television screens, and monitor for electronic games, tablet personal computers, and portable satellite radios. It is also an object of this invention to provide a cradle with adjusters to accommodate the different types of portable devices or different models of the same portable device such as different models of music players.

In another embodiment of the present invention a vehicle mounted system is disclosed. This system includes an electronic media storage device, or a handheld electronic device. The device is equipped with an interface and the electronic media storage device is adapted to convey a first signal, via the interface to an adapter where a signal processor is configured to derive a second signal from the first signal. This second signal may from time to time be referred to as a standard signal. The second signal is conveyable to a second signal processor, which is configured to derive a third signal from the second signal. The third signal is conveyable, directly or indirectly, to the consumer electronic device. The consumer electronic device, which might take the form of a radio, TV, or other device, is configured to use data derived form the third signal to create content which is perceivable to a user. The content includes at least a partial emulation of the functionality of the electronic media storage device. The consumer electronic device is set up to allow it to receive instructions from a user, based on at least partial emulation, and convey said instructions to said electronic media storage device.

The invention can take another form, wherein the signal processor is operationally situated between the vehicle mounted electronic device interface and the electronic media storage device physical interface. The vehicle mounted electronic device is interconnected with the electronic media storage device, via the vehicle mounted electronic device interface and the electronic media storage device interface. The vehicle mounted electronic device is configured to emulate at least a portion of the electronic media storage device user interface and the electronic media storage device is configured to convey an electronic media signal to said vehicle mounted electronic device. In this system it is also contemplated that a signal converter, configured to convert a signal from a first form associated with the electronic media storage device to a second form associated with the vehicle mounted electronic device would be included. This converter may be encapsulated within an interface or a wire. Further, the signal converter may be made interchangeable. A remote control unit may also be provided, which may be adapted to allow a user to control the handheld electronic device. The remote control unit may also be integrated with an existing function related to the operation of a vehicle, especially a motorized vehicle.

### BRIEF DESCRIPTION OF THE DRAWINGS

Referring particularly to the drawings for the purposes of illustrating the invention and its presently understood best mode only and not limitation:

FIG. 1 is a diagrammatic view of an embodiment of a system for replaceably mounting a plurality of hand held electronic devices to a plurality of heads;

FIG. 2 is a remote control device suitable for use with the present invention, and specifically suitable for controlling the handheld electronic device;

FIG. 3 is a diagrammatic view of another preferred embodiment of a system for replaceably mounting a plurality of hand held electronic devices to a plurality of heads within a confined system;

FIG. 4 is an illustration of various types of emulation, which are contemplated by the present invention;

FIG. 5 is an illustration of a simplified form of inter-device compatibility enabled with the present invention;

FIG. 6 is an illustration of the embodiment of the present invention showing a plurality of devices and the manner in which they can be matched to a docking element;

FIG. 7 is an adapter and base element either or both of which are configured to accept a removable signal processor;

FIG. 8 is an automobile dash that is associated with the handheld electronic device and the consumer electronic device;

FIG. 9 is the handheld electronic device as it is mounted into a cradle and interfaced with the docking member;

FIG. 10 is a integrated docking member and docking member circuit, where the two are separabley integrated, reflective of the possibility that a user may rarely switch between handheld electronic devices;

FIG. 11 is a side view of one embodiment of the system, as it is to be connected together;

FIG. 12 is a side view of the one embodiment of the system as it appears connected together;

FIG. 13 is a front view of one embodiment of the present system as it might appear in a car; and

FIG. 14 is a disconnected perspective view of an embodiment of the present system as it might appear in a car.

### DETAILED DESCRIPTION OF THE PREFERRED EMBODIMENTS

The present invention provides its benefits across a broad spectrum of user interfaces with electronic devices in a vehicle environment. While the description which follows hereinafter is meant to be representative of a number of such applications, it is not exhaustive. As those skilled in the art will recognize, the basic apparatus taught herein can be readily adapted to many uses. This specification and the claims appended hereto should be accorded a breadth in keeping with the scope and spirit of the invention being disclosed despite what might appear to be limiting language imposed by the requirements of referring to the specific examples disclosed.

Referring now to the drawings wherein like reference numerals designate identical or corresponding parts throughout the several views. It is to be understood that the drawings are diagrammatic and schematic representations of various embodiments of the invention, and are not to be construed as limiting the invention in any way. The use of words and phrases herein with reference to specific embodiments is not intended to limit the meanings of such words and phrases to those specific embodiments. Words and phrases herein are intended to have their ordinary meanings, unless a specific definition is set forth at length herein.

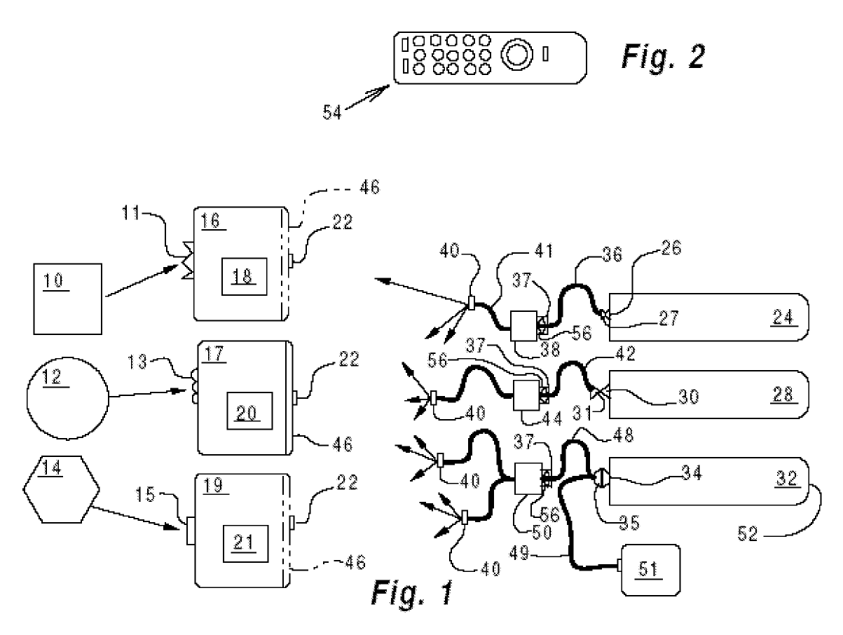

One embodiment of the present invention, diagrammatically shown in FIG. 1 includes a handheld electronic device 10, which may be, for example, an MP3 player, a cellular telephone, a GPS receiver, or the like. Additional handheld electronic devices that are different from handheld electronic device 10 are illustrated at 12 and 14, respectively. A separate docking station 11, 13, and 15 is provided for each of the handheld electronic devices 10, 12, 14. Each of the handheld electronic devices requires a different docking station by reason of having differing physical dimensions and electronic signal formats. The docking station 11 for handheld electronic device 10 is indicated at 11. Docking station 11 is associated with docking member 16. Likewise, docking station 13 is adapted to accommodate handheld electronic device 12 and interface with docking member 17, which is specially configured to receive it. Handheld electronic device 14 is similarly accommodated by specially configured docking station 15. Docking station 15 is associated with docking member 19.

Each of the docking members 16, 17, and 19 includes electronic circuitry, for example, docking member circuits 18, 20, and 21, respectively. Docket member circuits are specially adapted to receive unique electronic signal input from the respective associated handheld electronic devices 10, 12, and 14. Each handheld electronic device 10, 12, and 14 generates electronic signals in a particular device format that is unique to that particular handheld electronic device. These formats are conveyed via proprietary interfaces. For the first handheld electronic device 10, the handheld electronic device interface 24 is compatible with the interface 25 in the docking station 11. Similarly, for handheld electronic devices 12 and 14, the interfaces 26 and 28 are compatible with the interfaces 27 and 29 respectively. The inventor recognized that converting these unique device format electronic signals to a standard format that is independent of the particular handheld electronic device from which they originated together with other features of the present invention would greatly facilitate the integration of handheld electronic devices into other electronic systems. Such a standard electronic output can be transmitted through a standard docking member connection 22. The standard docking member connection 22 is compatible with any of the standard head connectors 26, 30, and 34. Electronic signals to and from the respective handheld electronic devices are converted by electronic circuitry 18, 20, and 21 from a standard format to the specific device formats that are required by the respective devices and vice versa. The docking member connection 22 is the same regardless of the docking member with which it is associated. As indicated by the arrows any connector 40 may be operatively mated with docking member connection 22.

Each of the docking members 16, 17, and 19 is adapted to being physically mounted to a base element 46. The base elements 46 is adapted to be mounted to a vehicle, optionally on a dashboard or other substrate (not shown). In the embodiment of FIG. 1, each docking member 16, 17, and 19 is configured for mounting on the base element 46. For a given installation, only one base element 46 is needed, although additional base elements 46 may be installed on a substrate, if desired. All of the docking members 16, 17, and 19 in the system are adapted to being interchangeably mounted to the same base element. Typically, one base element 38 is installed in a vehicle at a fixed location, and different docking members 16, 17, and 19 are removably mounted and dismounted from the base element 46 as desired. One embodiment of the system will optionally include a security chip, which will preclude the accidental use of a non-authentic or non-authorized product or component from being used with the system. The security chip may also be employed to add an extra level of security and protection against theft. The security chip could be made to be removable and once removed the system would cease to be functional. The replacement of the chip restores functionality. The chips may also be selected to control what types of content are delivered, as for example blocking certain video games, or blocking certain other content. The security chip also will help ensure that a consumer will be able to determine if a product is genuine or a counterfeit.

Control units are typically mounted in vehicles and on other substrates for purposes of controlling at least the audio and/or video systems in a vehicle or elsewhere. The heads may be integrated into other systems such as vehicle operating systems, alarms, warnings, and the like, so that they are controlled by or at least integrated with the head. Each vehicle manufacturer, for example, usually produces its own heads. Typical head units are shown, for example at 24, 28, and 32. One end of the head, for example, head end 52, is usually presented to the operator of the system and may include, for example, controls for turning on and off, controlling, and tuning radios, DVD players, and the like. Such heads frequently include within them DVD players, tape decks, and the like. The head end 52 is typically finished and detailed to be visually pleasing. The rest of the head is usually mounted within the substrate so that it is hidden from view. Each brand of head typically includes its own uniquely configured head connector, for example, 26, 30, and 34. The head connector 26 requires an especially configured cable head connector 27. Head 28 has a differently configured head connector 30, which requires specially configured cable head connector 31. Similarly, head connector 34 of head 32 requires its own specially configured cable head connector 35. Cable head connectors 27, 31, and 35 are not interchangeable. Thus, cable 36, with connector 27 must be provided for the circumstance where it is desired to connect a handheld electronic device to the system in which head 24 is mounted. Likewise, cable 42 with cable head connector 31 must be provided for connection to head 28, and cable 48 with cable head connector 35 must be provided if it is desired to connect to head 32. Cables 36, 42, and 48 serve to carry electronic signals formatted for a specific head between the heads 24, 28, and 32, respectively, and cable circuits 38, 44, and 50, respectively. Standard cable 41 is typical of the cables that carry electronic signals in a standard format between the cable circuits (for example, 38, 44, and 50) and the docking member circuits (for example, 18, 20, and 21).

A cable circuit 38 is provided in operative association with cable 36. The purpose of a cable circuit is to convert electronic signals between a standard format and a head format. Signals going to a head are converted by a cable circuit from a standard format that is the output from a docking member circuit into a specific head format that the specific head can accept and work with. Electronic signals coming out of the head are converted by the cable circuit from the head format for that particular head into a standard format that a docking member circuit can accept and work with. Cable circuit 38 is an electronic circuit (mounted on a circuit board, a chip, or the like) that is designed to convert the electronic output of head 24 into a standard format. The standard format is compatible with cable connectors 40 and standard docking member connections 22. The standard format is the required format for input from all heads (for example, 24, 28, and 32) to all docking member circuits (for example, 16, 17, and 19). Cable circuit 38 also serves to convert the electronic output from any docking member into the special format that is required by the specific head 24. Likewise, cable circuits 44 and 50 serve to convert electronic input and output to and from heads 28 and 32, respectively.

For those situations where more than one base element is mounted on a substrate, the standard cables on the base element side of the cable circuit may be branched to provide two or more standard cable connectors 40. See, for example, the typical branched standard cable that extends between cable circuit 50 and base elements 46 where two standard cable connectors are attached to two branches of this reach of the standard cable. If desired for a particular installation, more than two branches may be provided on a standard cable. For ease of installation the cables and standard cables are typically several inches to several feet long, but they may be of any length desired. The cables may, for example, be so short that they only extend within an adapter that houses both a head connector and a cable head connector. The standard cable 41 and cables 36, 42, and 48 may be flexible or rigid as may be desired. So long as they contain conductive elements, the cables may be of any desired form, even including conductive traces painted on or otherwise applied to a substrate. An ancillary component 51, which accepts the head specific signal may be fed from the same cable 48, via cable 49 to the device 51.

For purposes of reliability, performance, capacity, and security it is generally preferred that there be a physical conductor connected between the cable circuit and the base element. See, for example, standard cable 41. For remote or difficult installation, however, it may be desirable to use a wireless connection (not shown) in place of standard cable 41. In such an installation standard cable connector 40 and standard docking member connection 22 become antennas (not shown) and there is no solid phase physical conductor attached between them. For purposes of this specification and the claims appended hereto, unless otherwise indicated the phrase “standard connection” is intended to and shall include all connections between docket member circuits and cable circuits, including antennas, standard cable connectors and standard docking member connections. In addition, in a wireless installation base element 46 may become primarily a holder for the docking member, which may be permanently or temporarily mounted wherever desired so long as it is within wireless range. The antenna that is associated with the docking member circuit in a wireless installation may be associated with the base element, the docking member, or elsewhere, as may be desired. The cable circuits and docking member circuits include the capability to transmit signals in a wireless installation.

Preferably, both the electronic input and output signals that flow through connectors 22 and 40 are all standardized. The electronic input and output that flows through connector 26 is unique to head 24. The electronic input and output that flows through connector 30 unique to heads 28 and 32, respectively. The electronic input and output that flows through docking connectors 11, 13, and 15 is unique to each device-docking member pair. That is, the electronic input and output that flows through docking connector 11 is unique to the device 10. Similarly, the electronic input and output through docking connector 13 is unique to handheld electronic device 12.

The inventor realized that conversion of input and output electronic signals to a predetermined standard, which applies between cable circuits 38, 44, and 50, and docking member circuits 18, 20, and 21, however matched, substantially minimizes the number of docking members that are required. Without such standardization, each individual handheld electronic device would require a docking member for each individual head style. That is, to accommodate handheld electronic device 10 there would have to be a separate docking member for each of heads 24, 28, and 32. According to the present invention, the cables and associated cable circuits must be changed to accommodate each different head, but this is considerably less expensive than providing a docking member for each head style.

The electronic circuits that are employed as cable circuits 38, 44, and 50, and docking member circuits 18, 20, and 21, may be placed on circuit boards or chips, or the like, and may include both hardware and software. The software may reside, for example, partially or entirely in volatile or non-volatile read only memory (ROM). The ROM may, for example, be reprogrammed from time to time as desired to accommodate changes in the system. Production costs may be minimized by incorporating all of the cable circuits into one chip, printed circuit board, or the like. The cable circuit is then configured for the particular head to which it is attached. Such configuration may be accomplished, for example, manually by changing dip-switch settings, through software, or even automatically by software within the cable circuit that detects the head to which the cable circuit is connected.

The present invention is suited, for example, to aftermarket installations where kits are designed to accommodate many different heads in different preexisting vehicles or other substrates. A kit may, for example, be intended to be employed with one of four different heads and two different handheld electronic devices. Such a kit would include four different cables, each of which has a different cable head connector and cable circuit associated therewith. It would also include two different docking members, each of which has a docking member circuit that is unique to a particular handheld electronic device. The kit would also include at least one base element. Typically, the base element would be mounted to a vehicle or other substrate in which there is already a head. The appropriate cable would be selected from the kit to match the head. The selected cable and associated cable circuit would be attached between the head and the base element. The docking member that is unique to the first handheld electronic device would be selected from the kit and mounted on the base element. The first handheld electronic device may then be docked in the docking member to integrate such device with the audio, visual, control, or other systems, or the like, that are associated with the preexisting head. Integrating the second handheld electronic device with such existing systems would require replacing the docking member with one that is unique to such second device. As will be understood by those skilled in the art, other arrangements are possible once the teachings of the present invention are understood. For example, it may be desired to dock two or more handheld electronic devices at the same time. To accomplish this, multiple docking members would be mounted to the substrate through two or more base elements. The cable between the cable circuit and the multiple base elements would be branched to provide for the mounting of two or more standard cable connectors to the same cable. Enough cable connectors would be provided to afford connections to all of the base elements. Two or more handheld electronic devices could thus be docked at the same time, if desired. Also, even if not simultaneously docked, such multiple base elements would permit different handheld electronic devices to be docked without changing docking members. Kits may be assembled at the point of sale. For example, one kit, comprising a cable, a cable circuit, and a standard cable, may be stocked for each head style. Other kits, comprising a may be stocked for each handheld electronic device.

Referring to FIG. 2, a remote control device 54 is depicted, the purpose of the remote control device 54 is to allow a user to control the handheld electronic device 10, 12, or 14. One unique feature is that the remote control device 54 signal receiver (shown at FIG. 2) is along the cable 41, and as such can serve as a universal remote allowing a user to control the content delivery of the handheld electronic device 10, 12, or 14 without any customization. The customization takes place in the docking member circuit 18, 20, or 21.

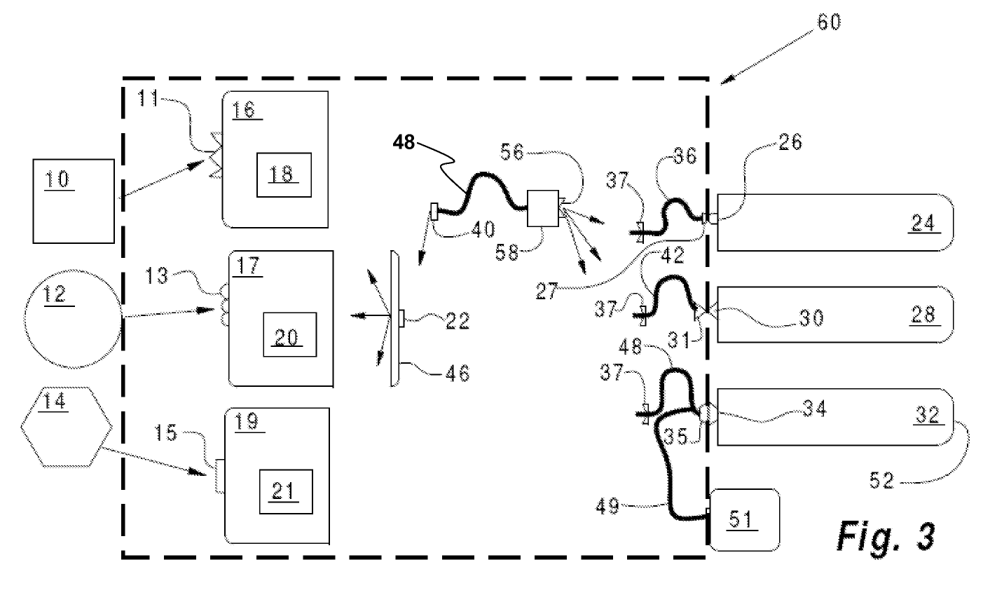

In another embodiment of the present invention, shown in FIG. 3, a kit is provided. In one configuration the method of operation includes placing an handheld electronic device 14 into docking element 15 on docking member 19, the signal passes to docking member circuit 21 where it is converted form an handheld electronic device specific signal type to a standard signal type. The docking member 19 interfaces with base element 46 and the signal passes via docking member connection 22 to cable connector 40. Thereafter the signal is conveyed via wire 41 to cable circuit 58 where the signal is converted from a standard format to a head specific format. The signal is then conveyed via connector 56 to connector 37 these connectors may be physical connectors, wireless transceivers or simply wire. The signal is then conveyed via wire 36 (although wires 42 and 48 could also have been selected) to the uniquely configured head connector 26 which interfaces with reciprocal uniquely configured head connector 27 on the head 24. The uniquely configured head connector 30 which interfaces with reciprocal uniquely configured head connector 31 on the head 28 could have been selected as could have the uniquely configured head connector 34 which interfaces with reciprocal uniquely configured head connector 35 on the head 32. Note, that the wire 41 could be substituted for a wireless connection. The kit is for electronically integrating at least a specific handheld electronic device 10 with at least a specific head 24. according to one embodiment of the present invention, at least one docking member 16 is provided. The docking member includes a docking member circuit 18, and the docking member is adapted to physically holding at least said specific handheld electronic device 10. The docking member circuit 18 is adapted to convert electronic signals between a device format, which is specific to the specific handheld electronic device 10, and a standard format. The docking member circuit 18 is in communication with the specific handheld electronic device 10 using the device format. The cable circuit 58 converts signals between a head format that is specific to said specific head 24 and the standard format. Thereafter, the cable circuit 58 conveys signals between the specific head 24 and the cable circuit 58 using the head format. In this manner, the docking member circuit 18 and said cable circuit 58 facilitate communication between the head 24 and the handheld electronic device 10. It is anticipated that the docking member circuit 18 and cable circuit 38 will communicate over physical cable or wirelessly. Similarly, the kit may include at least one head 28 and mating cable circuit 58.

When the device 60 is installed and mobile electronic device 10 fits into the docking connector 11. The mobile electronic device 10 connects to the docking connector 11 found on docking member 16. The docking member 16 is used to connect to the docking member connection 22 which is part of the wiring 41. The wiring 41 fits through a hole located somewhere in the body of the vehicle (not shown). The wiring 36 is behind the vehicle's body and is connected to one or more electronic components of the vehicle, including onboard computers and consumer electronic devices with heads 24.

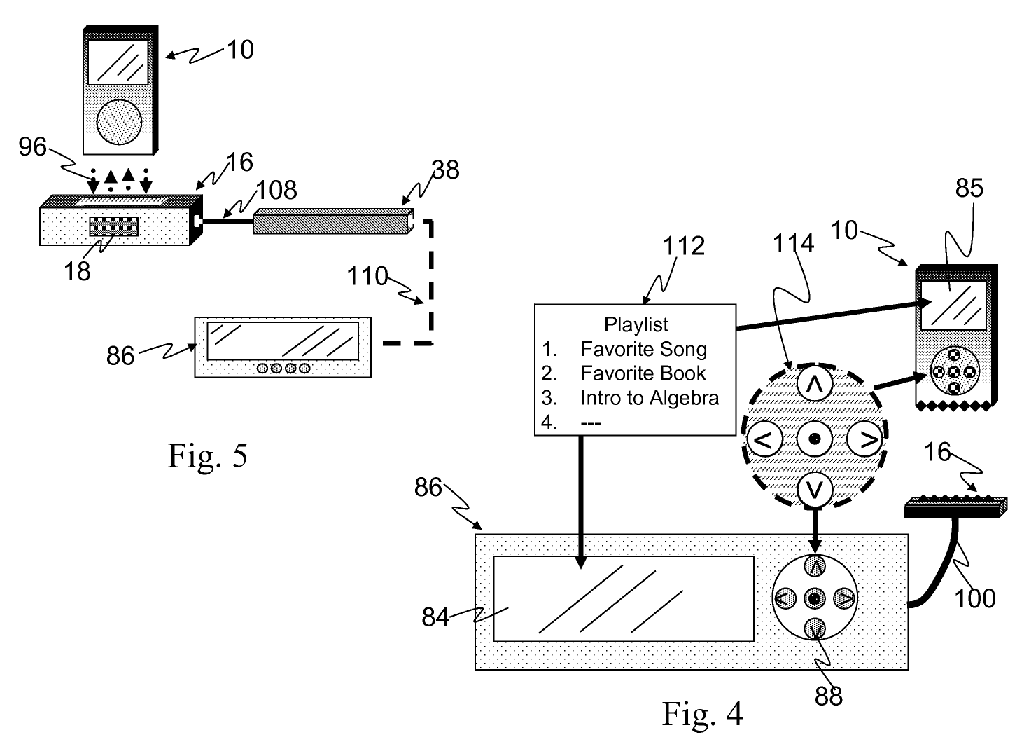

In another embodiment, depicted in FIG. 4, vehicle mounted consumer electronic device 86 such as a television, radio, display screen or multifunctional device is provided. The consumer electronic device 86 is operatively interfaced with a handheld electronic device 10 such as a Zune®, an iPod®, a Creative®, or any other media player and/or recorder. The vehicle mounted consumer electronic device 86 is operatively interconnectable with the handheld electronic device 10 via the wire 100 and through the docking member 16 and the vehicle mounted consumer electronic device 86 is operable to display at least a portion of user interface display data 112 associated with said electronic media storage device. The interoperability is accomplished with the aid of the docking member circuit and/or the cable circuits previously discussed. The handheld electronic device 10 is operable to convey and receive data sufficient to allow a consumer electronic device 86 or a remote control device to emulate the handheld electronic device 10. The user interface 114 may be associated with the consumer electronic device 86 or a remote control device. As with other embodiments disclosed herein, it is contemplated that the docking member circuit and/or the cable circuits are optionally encapsulated within the docking member 16 or within the wire 100. It is also contemplated that the docking member circuit and/or the cable circuits are interchangeable and that the interchangeability is optionally based on the handheld electronic device 10 signal output. Optionally interchangeability is based on the handheld electronic device external interface. The system optionally includes a remote control unit operable to control the handheld electronic device 10 and/or the consumer electronic device 86. As previously indicated it will generally be desirable to have the remote interface with the signal where the signal has been standardized. The remote control will, optionally, be integrated with a vehicle control system. A vehicle control system would include a keyless entry remote control, an ignition key, an alarm control, a light controller. Further, the remote control may be customized to reflect functionality which is unique to a specific media player or handheld electronic device 10, or series of handheld electronic devices. The remote control is expected to have between 2 and 20 switching components. More commonly, there will be fewer than 10, in some cases, there will be exactly 4, or 5 or 7 in other cases there will be around 7, around 4. In some cases, the remote control will include at least seven switching components but the remote will be functionally limited to four or five switching components. In another embodiment there are at least seven switching components but the remote functionally limits a user interface to the number of switching components associated with a given media player or handheld electronic device. The handheld electronic device may include a variety of media storage devices, including media storage devices with the ability to download data from a distributed database, or a localized database. It is specifically contemplated that an electronic file player, an optical file player, and a magnetic file player will be included.

In FIG. 5, a handheld electronic device 10 is operatively interfaced with a docking member 16 and a handheld electronic device-specific signal 96 is communicated between the docking member 16 and the handheld electronic device 10. The signals pass through the docking member circuit 18, where the handheld electronic device-specific signal 96 in the direction of the consumer electronic device 86 is converted to a standard signal 108. Similarly, the standard signal 108, on its way to the handheld electronic device 10 is converted to the handheld electronic device-specific signal 96. The cable circuit 38 converts between the standard signal 108 and the consumer electronic device-specific signal 110. In this manner a signal 96 originating with a handheld electronic device is conveyed to the docking member circuit 18 where it is converted to, what shall be termed herein, a standard signal 108, the standard signal is conveyed to the cable circuit 38 where it is converted to a signal 110 which is accepted by the consumer electronic device 86. The reverse transmission is also contemplated, but need not occur. In the reverse mode, it is contemplated that the functionality of the handheld electronic device 10 will be made resident on the consumer electronic device 86.

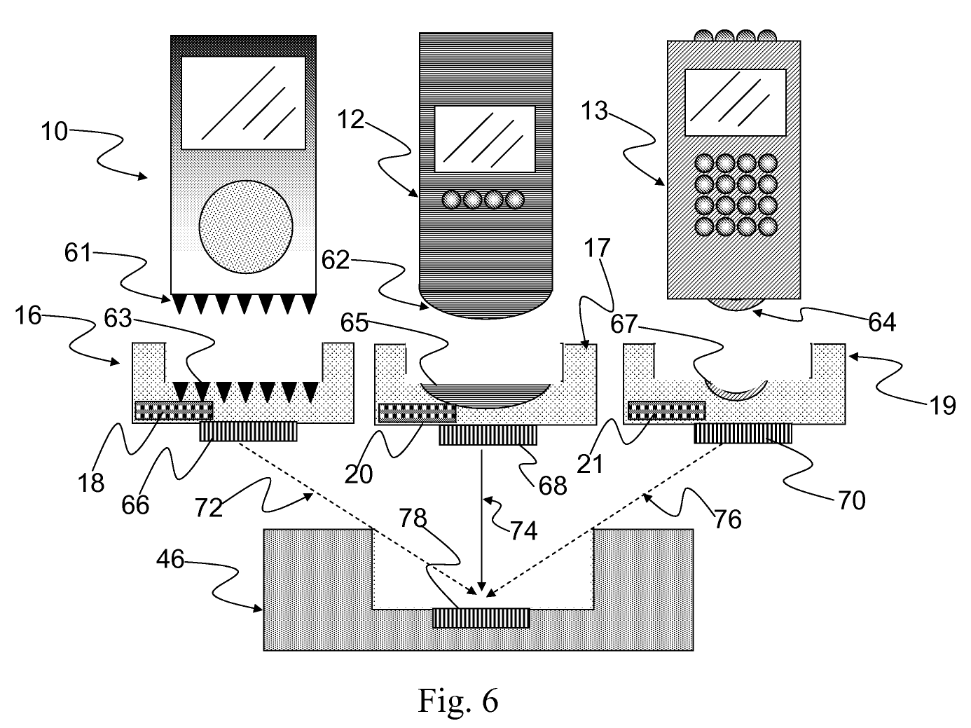

Another embodiment of the present invention is illustrated in FIG. 6, where the handheld electronic devices 10, 12, 14 each include a unique and/or proprietary interface or first physical handheld electronic device interface 61, 62, 64. This interface is received by the second physical handheld electronic device interface 63, 65, and 67 which is part of the adapter or docking member 16, 17, and 19. The docking member further includes a first standard physical adapter interface 66, 68, and 70 and in another embodiment, a second physical adapter interface (not shown in FIG. 6). The docking member 16, 17, and 19 further includes a first signal processor or docking member circuit, 18, 20, and 21. The circuit 18, 20, and 21 is configured to receive a signal, as from one of the handheld electronic devices, 10, 12, and 14 and translate the signal to a standard format. Where standard is standard to the system, not necessarily a universal standard. The standard signal may then be conveyed, via the first standard physical adapter interface 66, 68 and 70, to the base element 46, where a third standard physical adapter interface 78 is configured to receive the signal from the first standard physical adapter interface 66, 68, and 70. It should be noted that FIG. 6 only shows base portion 46 but shows three handheld electronic devices 10, 12, and 14. While there may be a plurality of base portions, it is contemplated that only one docking member 16, 17, and 19 would be accommodated at a time for each base portion 46. The base portion however may be modified to include a plurality of handheld electronic devices at one time if desired. Further, while the base portion 46 is shown having walls, this need not be the case, the base station may be a receptor on a wire, a fully enclosed case which securely retains the handheld electronic device or something in between. In the event that a fully enclosed case in contemplated it may be mounted in various places in a vehicle and may rely on a spring loaded door which is dimensioned to allow access on the handheld electronic device and when fully inserted be completely out of sight, the loading of the door may also be pneumatically, gravitationally, or otherwise biased. In another embodiment, a drawer like system may be pulled out making the base element 46 available. The embodiment described in FIG. 6 is suited, for example, to an original equipment manufacturer (OEM) installation. It will be noted that the cable circuit 44 of FIG. 1 is absent. This is because there will be no need to match the base element to the head unit as this will be done at the factory. For instance, in this case, the standard signal will be compatible with the resident head unit. All that is needed with a single head is a plurality of docking members to accommodate different handheld electronic devices, and one cable without any cable circuitry. The docking member circuitry is sufficient to convert the input and output of the various handheld electronic devices directly to the format required by the OEM's head. It is possible to mount the interchangeable docking members in a cassette tray that slides in and out of the head unit like a conventional cassette tape. Again, since only one head is involved, there would be no need for more than one circuit board, specifically the docking member circuit.

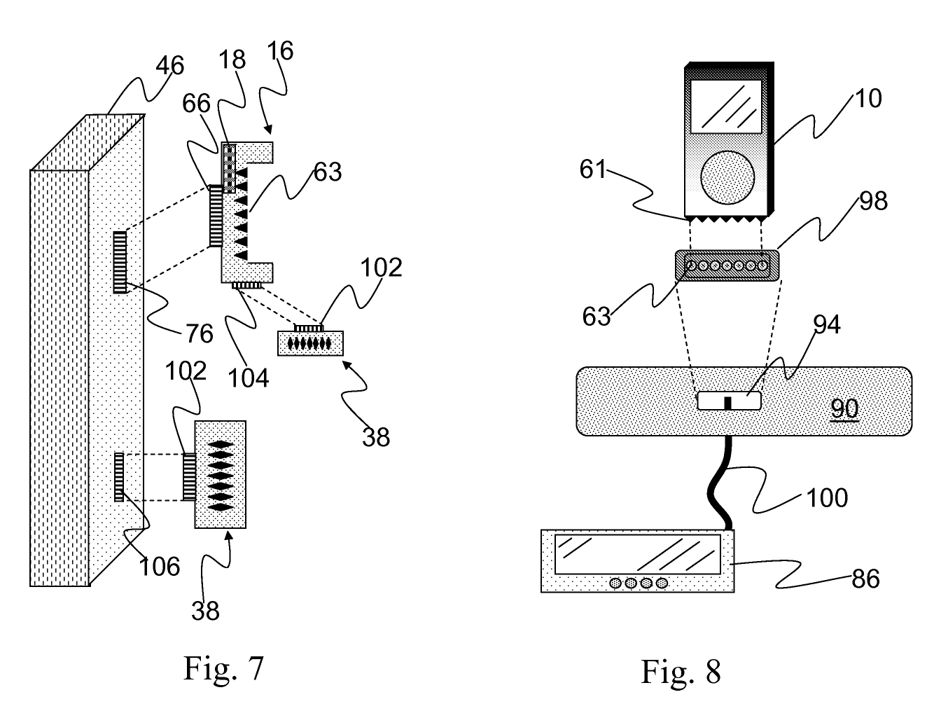

Another embodiment of the present invention is illustrated in FIG. 7, where the cable circuit 38 is a detachable module which is selected to match the specific head. The detachable module cable circuit 38 includes an interface, shown as a standard physical adapter interface 102, which is configured to be received by the docking member 16 at port 104. In another embodiment, there may be more than one cable circuit 38 or the same cable circuit may, optionally, be placed on the base element 46. In such a case, the base element would have a port 106 to receive the adapter interface. This embodiment is especially useful in the aftermarket environment because it allows a consumer to select a docking member based on the consumer's handheld electronic device and to separately select the cable circuit 38 based on the head that they want to match. As shown, it is anticipated that the cable circuit 38 can attach to the docking member 16, the base element 46, or both. It is also envisaged that two or more cable circuits 38 may be used or that the cable circuit 38 may be operatively linked to a database, where the link may be wireless or wired, and the database may be local, distributed, or non-local and non-distributed. The database may also require a subscription or be tied to a compact disc, thumb drive (with or without a USB port) or other media storage system. It is noted that the use of a wireless remote control 54 would likely include the placement of a remote control receiver, and the receiver would be inserted between the docking member circuit 18 and the cable circuit 38, that is, it would interface with the standard signal, which exists between the two elements. It will be further noted that the handheld electronic device 10 is configured to deliver a signal via a first physical handheld electronic device interface to the second physical handheld electronic device interface 63, into the docking member, through the docking member circuit 18 to the third standard physical adapter interface 104. Thereafter the signal is routed to the fourth standard physical adapter interface 102 and then back to the docking member 16. Next, the first standard physical adapter interface 66 conveys the signal to the third standard physical adapter interface 76. It is noteworthy here that the present invention also contemplates a wireless connection between the circuit 18 and circuit 38. The base element 46 is operatively interfaced with a consumer electronic device 86. The modifier “consumer” is intended to distinguish this embodiment from other contemplated embodiments where the handheld electronic device 10 is interfaced with on-vehicle computers, such as status and diagnostic computers with which the handheld electronic device is also capable of communicating. The base element 46 provides data from the handheld electronic device 10 to the consumer electronic device 86. It is contemplated that two forms of data will be provided content and metadata. The content might include music, videos, music videos, lectures by Professor Feynman, video games and other content. The metadata might include track, artist, battery condition, minutes left, etc. Referring now to FIG. 4, the metadata is optionally displayed on the consumer electronic device display 84. The function keys on the handheld electronic device may also be emulated on the remote control or the consumer electronic device 86 itself, using existing user interfaces 88. It is also contemplated that various components on the consumer electronic device 86 could be captured to functionally serve to emulate the functionality of the handheld electronic device 10. In the event the handheld electronic device 10 functionality is more limited than the functionality of the consumer electronic device 86 or the remote, the perceivable portion of the interface may be reduced so as more closely align the apparent functionality of the consumer electronic device 86 or remote with that of the handheld electronic device 10.

With specific focus on vehicle diagnostics, the present invention is capable of providing data from an on-board computer to a handheld electronic device 10. The handheld electronic device 10 optionally includes a wireless transmitter and can be used to transmit data from the on-board computer. The handheld electronic device 10 is also configured to be usable in the home environment and to interface with electronics in the home, including entertainment systems and computers, as well as industrial systems, including diagnostic and/or monitoring tools. Video games, according to the present invention could be played using a single handheld electronic device 10 and each player using a remote control device 54. The video game content could be delivered to a variety of TV screens, or display consoles located throughout the vehicle, home, or business. The console screens could also be made to disappear from sight through the use of a drawer like system where the screen would fold to an angle substantively perpendicular to the viewer and then slide into a wall, bulkhead, or other barrier.

Another embodiment of the present invention provides a way for mobile electronics to connect to a vehicle's electronic components through the use of an interchangeable docking station. The docking station is detachable from the wiring that connects it to the vehicle's electronic components. By making the dock detachable from the wiring, another dock for another mobile electronic device can be connected to the wiring. This allows for any mobile electronic device to be connected to a vehicle's electronic components through the use of this docking system.

In another embodiment, the dock is removable which allows for a user to switch between virtually any mobile electronic devices connecting them to the vehicle's electronic components. In such a case, it may desirable to have a system interface which includes little or no generic circuitry. In another embodiment, the handheld electronic device 10 and the consumer electronic device 86 are interconnected using a solid conductor (as opposed to a wireless connection scheme). The wiring for this device is concealed, optionally, behind the vehicle's components or body; the exception would be the connector or aperture for the connector which allows the dock to connect to the wiring. By using this method, any mobile electronic device is able to connect to a vehicle's electronic components (including, without limitation the automobile's on-board computer, diagnostic tools, driving history data etc.) with the corresponding interchangeable dock and maintain a look of being seamlessly integrated into the vehicle by having the wiring concealed behind the body of the vehicle.

This device is able to achieve its results by threading the wiring through a hole either pre-existing or drilled into the body of the vehicle where the device system interface is to be placed. Once the wiring is threaded through the hole is it then connected to at least one, and potentially all of the vehicle's electronics. The connector at the opposite end of the wiring sticks out of an aperture while the wiring itself is concealed, optionally, behind the body of the vehicle. The connector allows for the system interface to connect to the wiring previously installed. The system interface itself can contain a circuit board to allow for the transfer of any and all data from the mobile electronic device to vehicle's electronics or visa versa, should one be needed. Once the system interface is connected to the wiring, it then achieves the result of giving the device a seamlessly integrated look. The dock itself is interchangeable at any time, allowing any device to connect to the vehicles electronics via the stationary wiring and an appropriate dock.

There are numerous embodiments of this invention. In can be placed in any type of home, office business, vehicle including a car, train, plane, automobile, motorcycle, boat, submarine, space vehicle, etc. It can be located in any position in the vehicle including in the dashboard, between the seats, on the floor, in the doors, the sideways, the ceiling, consumer electronic device receptacles, exterior body, etc. The cable circuit 38 and docking member circuit 18, it is just housed within the system interface. The system interface can be made of plastic, metal, wood, or any other material suitable for holding a mobile electronic device. The connector on the docking member 16 which connects the handheld electronic device to the circuit board can be located anywhere in the dock and have as many conductors as are needed in order to connect to the mobile electronic device. Any number of connectors can be used in order to transfer the data from the mobile electronic device to the electronic components of the vehicle and vice versa. The electronic components of the vehicle can be the stereo, monitors, on board computer, etc. The dock itself could be molded into the vehicle's body in such a way as to make a part of the vehicle and can either be as one piece or still have the dock interchangeable. The housing for the base element and the docking member circuit 18 can be concealed directly behind the body of a vehicle but still allow for access to the circuit board and/or the connector for connecting the mobile electronic device to. This could be achieved by having a concealed opening where the dock or housing for the circuit board along with the circuit board resides. Through the concealed opening, the dock and/or the circuit board or just connector can change out for the corresponding mobile electronic device.

Another embodiment of the present invention includes a vehicle comprising an occupant region, and a component region wherein the regions are adjacent one another. The vehicle itself may take the form of any powered or non-powered vehicle that can accommodate an occupant; this could include an automobile, aircraft, marine vessel, or other vehicle. The solid-state electronic device is configured to receive electromagnetic radiation, likely in the from of a signal which may subsequently be converted into an electromagnetic or electromechanical radiation signal which may be perceived. The solid-state electronic device further includes a user interface including a data input region. The data input region may use a tactile based unit, this could include a touch screen, and may include a fingerprint reader or other authenticating element, and the interface may be visual based or audio based. In a preferred embodiment, there are multiple user interfaces. The present invention also contemplates that a single handheld electronic device may be used to feed multiple consumer electronic devices. Additionally, a first electrical component including a communications protocol is included as well as a signal source for, and in operative connection with, at least one electromechanical radiation transmitting device and a system interface. Additionally, a cable having a first end and a second end, wherein the first end is in electrical contact with the solid state electronic device and the second end terminates with the system interface, which is substantively immovably disposed within the occupant region of the vehicle and is within 3 meters, 2.5 meters, 2, meters, 1.5 meters, 1 meter or 0.5 meters of the seat. It is further contemplated that different interfaces may be placed strategically throughout the occupant region and at varying distances from the occupant. Additionally, the cable includes at least two electrically conductive wires. In another embodiment the system includes an adapter component having a first side and a second side, wherein the first side operatively forms an electrical connection with the system interface and the second side of the adapter component is configured to connect to at least one electronic data storage device using data interface which is on the electronic data storage device, wherein the electronic data storage device includes a user interface, and the adapter component includes a communications protocol operative to permit at least partial emulation of the electronic data storage device user interface on the solid state electronic device.

In another embodiment the system includes at least one electronic data storage device including at least one communication protocol; and an electrical component including an dynamic sensing protocol wherein the electrical component is capable of sensing the presence of at least one electronic data storage, such as an handheld electronic device 10 in electrical contact with the system interface. After sensing the presence of the at least one electronic data storage device, the electrical component dynamically queries the electronic data storage device or devices and ascertains sufficient data concerning the communications protocol of the electronic data storage device or devices to allow the interface to transmit electrical signals through an electrically conductive medium from the at least one electronic data storage device to the solid state electronic device, wherein the solid state electronic device, at least partially, emulates the user interface of the electronic data storage device and the solid state electronic device converts at least a portion of the data transmitted from the electronic data storage device to the solid state electronic device to a signal which is configured to ultimately provide a signal to an electromechanical transmitting device.

Another embodiment of the system, illustrated in FIG. 8 includes a dash 90, which includes a resilient substantially non-conducting polymeric material. The dash 90 includes first region which optionally includes at least one fastening device (not shown) and a second region including an aperture 94 and a cable 100 including a first end and second end and at least two electrically conductive wires therein. The aperture needs to be dimensioned to so as to accommodate the cable 100. The aperture receives the first end of the cable 100, and the cable 100 is operatively connected to an electronic interface 98 (the interface 98 is shown detached for the purposes of clarity). The interface 98 is integrally affixed to the dash 90 and the electronic interface 98 is operative to accommodate a first handheld electronic device 10. The handheld electronic device 10 is configured to transmit electromagnetic signals to a consumer electronic device 86 attached to the wire 100 at the second end of the wire. The electronic interface 98 is adjacent to an optional integral discontinuity (not shown), wherein the discontinuity is operative to provide a retaining characteristic for at least one of the following, handheld electronic device 10 and a docking member (not shown). In a simple form, this embodiment provides an automotive component, such as a dash 90, made of resilient material and fitted with a jack to accommodate a standard plug, attached to the plug on the vehicle side is a means for conveying a signal to and from a consumer electronic device 86. On the occupant side, the plug is configured to accept an adapter which is customized to physically adapt the output of a handheld electronic device to make it possible to convey the handheld electronic device signals to the consumer electronic device 86.

In a variation of the FIG. 6, the docking member circuit 18 and the cable circuit 38 rely on a query protocol to determine the type of handheld electronic device 10 and consumer electronic device 86 that exist in the system. This embodiment includes a universal querying interface which is configured to query any handheld electronic device and match the handheld electronic device 10 signal to any head unit 24, with the understanding that this system may rely on a resident protocol database or a external database, including a remote wireless or internet based database, or a combination of a local protocol and more comprehensive remote database, which optionally may require a subscription to access. In the event that the system cannot identify the protocol, the system may prompt the user to select from a plurality of options including a wireless transmission from the handheld electronic device to the consumer electronic device 86.

In another embodiment, a handheld electronic device dock is accessibly mounted in the occupant region. The electronic media storage device interfaces with the dock. The dock is operatively connected with at least one media presentation component. In this paragraph, media presentation component shall be understood to mean one or more speakers and optionally one of more viewing screens. More specifically, a handheld electronic device is interfaced with the dock and the media content is delivered to the vehicle occupants. In a specific embodiment, the dock can accommodate music and video versions of handheld electronic devices, and the dock is interfaced with a component that is interfaced with a transmitting system and the system allows the user to purchase/acquire and download multimedia material using the handheld electronic device as a storage system. The material that has been downloaded then may be enjoyed or may be stored for future enjoyment, or both. In another embodiment, the same docking port also allows a personal data assistant (PDA) to be interfaced with the docking port. In such a case the PDA user's schedule, email, etc could be viewed on a screen within the vehicle. This could be coupled with voice recognition software so as to obviate the need for a vehicle operator to read the email but would allow the operator to listen to the email and respond to the email by speaking. The PDA may also include a data book such as Zagat® or the yellow pages which would allow a user to identify nearby establishments which would be of interest to a vehicle operator or to others. A GPS (satellite or terrestrial based navigation system) containing data device could also be used to provide data which would aid in navigation.

In another embodiment, the docking station is situated so as to be out of direct sunlight. In another embodiment, the dock is mounted out of sight, so as to reduce the likelihood of thieves stealing the memory storage device. Locations include a ceiling mounted docking station which is accessible by a cover that opens by swinging downward between about 15 and 90 degrees and more preferably about 45 degrees. The cover has a docking portion on a side away from the hinge side. The memory storage device is placed in the docking bay with the aid of gravity. Thereafter the cover is closed and the memory storage device is out of sight. A similar set-up could be used in the vehicle's door or consol area. Similarly, an aperture could be provided which would substantially accommodate the memory storage device thus removing it from sight. Consistent with the invention the aperture would be sized to accommodate the largest anticipated device and would be associated with a plurality of adapters which would allow smaller devices to fit snugly within the aperture.

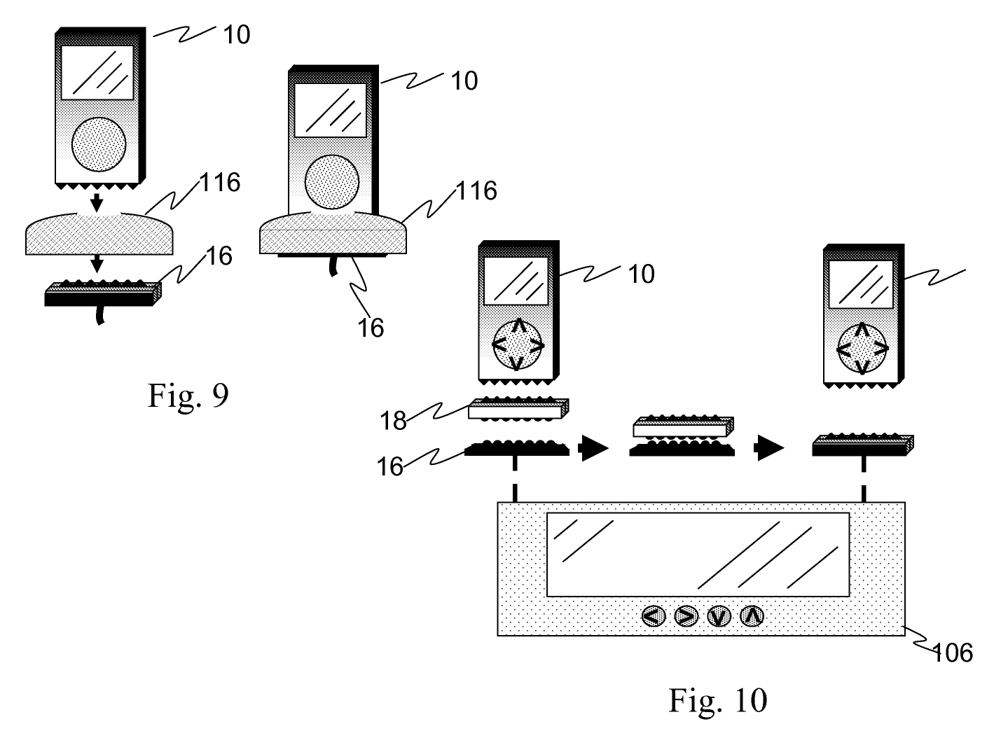

In another embodiment, seen in FIG. 9, the handheld electronic device 10 is matched to a cradle 116, the cradle 116, may include an insert not shown, which will allow for a snug fit of the handheld electronic device 10. The cradle 116, in this embodiment, sits atop the docking member 16. The handheld electronic device 10 is thus interconnected with the consumer electronic device 86 or other device such as an on-board computer. In FIG. 10, the handheld electronic device 10 interfaces with a docking member 16 that includes both a handheld electronic device interface and a docking member circuit 18. The objective here is to use a single component, which could be integral with a plug/physical interface at the end of a wire to accommodate a handheld electronic device 10 and interface the same with a consumer electronic device 86, or other electronic device.

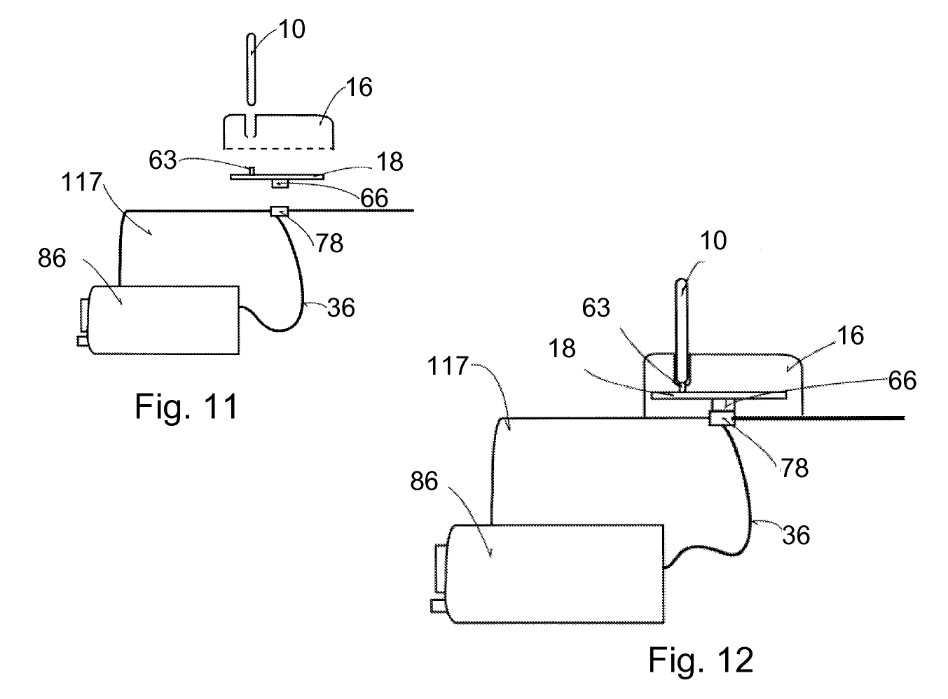

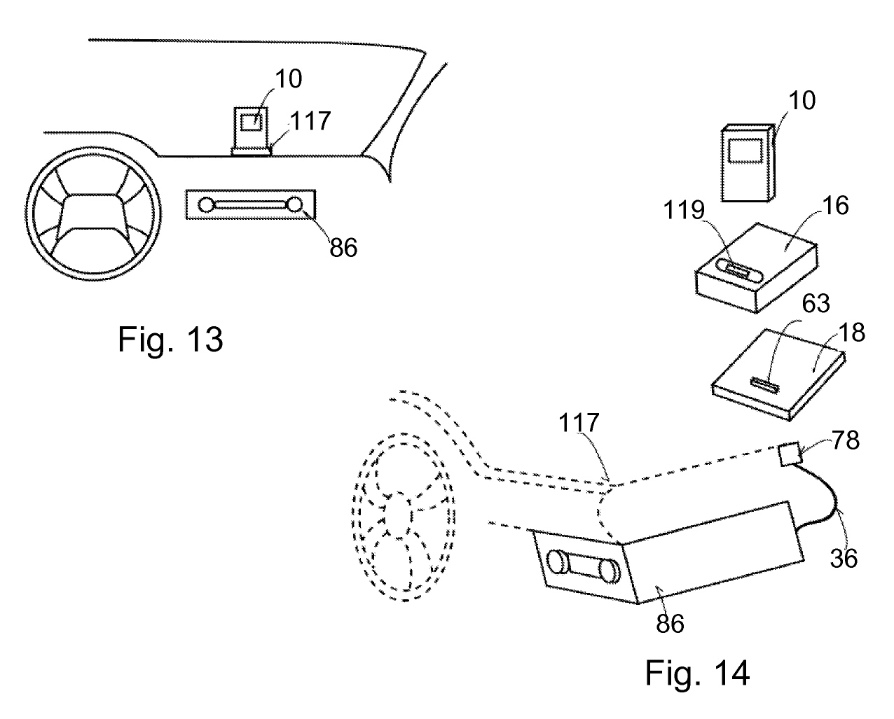

In another embodiment, illustrated in FIG. 11, the mobile electronic device 10 sits inside of a dock 16. The mobile electronic device 10 can connect to a connector 63 which is located on the circuit board 18. The circuit board has a second connector 66 which further connects to the connector 78 which is a part of the wiring or cable 36. The connector 78 fits into a hole located somewhere in the body of the vehicle 117. The wiring or cable 36 is behind the vehicle's body and is connected to any or all electronic components including a consumer electronic device 86 of the vehicle 117. FIG. 12 shows that the mobile electronic device 10 fits into the dock 16. The mobile electronic device 10 connects to a connector 63 found on the circuit board 18. The circuit board 18 has a second connector 66 which is used to connect to the connector 78 which is part of the wiring or cable 36. The connector 78 which is part of the wiring 36 fits into a hole located somewhere in the body of the vehicle 117. The wiring 36 is behind the vehicle's body and is connected to any or all electronic components, including, without limitation the consumer electronic device 86 of the vehicle 117. In FIG. 13, the device 10 is shown completed and installed inside a vehicle. The mobile electronic device 10 is sitting inside of the dock 16 which is located on the vehicle's body 117. In this case specifically, the mobile electronic device 10 is connected to the vehicle's electronic components such as the consumer electronic device 86 through the entirely assembled device which is transferring any data from the mobile electronic device 10 through the hidden wiring 36 to the vehicle's electronic components, shown here as a consumer electronic device 86. In FIG. 14 a perspective view of the device is presented disconnected. The mobile electronic device 10 fits into the dock 16. The circuit board 18 sits inside of the dock 16. The connector 63 on the circuit board 18 fits into the hole 119 found in the dock 16. The connector 78 which is part of the wiring 36 connects to the circuit board 18 through a hole in the vehicle's body 117. The wiring 36 connects to the electronic components of the vehicle, in this case a consumer electronic device 86.

Obviously many modifications and variations of the present invention are possible in light of the above teachings. It is therefore to be understood that, within the scope of the appended claims, the invention may be practiced otherwise than as specifically described.

What is claimed is:

1. A kit for electronically integrating a specific handheld electronic device with a specific head comprising:
at least one docking member including a docking member circuit, said docking member being adapted to physically holding at least said specific handheld electronic device, said docking member circuit being adapted to converting electronic signals between a device format that is specific to said specific handheld electronic device and a standard format, said docking member circuit being in communication with said specific handheld electronic device using said device format; and
a cable circuit adapted to converting electronic signals between a head format that is specific to said specific head and said standard format, said cable circuit being in communication with said specific head using said head format, and said docking member circuit and said cable circuit being adapted to communicate with one another using said standard format.

2. The kit as set forth in claim 1, wherein the at least one docking member and cable circuits communicate over physical cable.

3. The kit as set forth in claim 1, wherein the at least one docking member and cable circuits communicate wirelessly.

4. A vehicle mounted system comprising:
an electronic media storage device, including:
a first physical electronic media storage device interface;
an adapter, including:
a second physical electronic media storage device interface; and
a first standard physical adapter interface;
a second standard physical adapter interface; and
a first signal processor;
a second signal processor including:
including a third standard physical adapter interface; and
a standard interface including
a fourth physical adapter interface;
a consumer electronic device including
a display; and
a user interface;
wherein the electronic media storage device is configured to convey a first signal, via the first and second physical electronic media storage device physical interfaces, to the adapter where the signal processor is configured to derive a second signal from the first signal and the second signal is conveyable to the second signal processor via the first and third standard physical adapter interfaces and the second signal processor is configured to derive a third signal from the second signal and the third signal is conveyable to the adapter via the third and first standard physical adapter interfaces, and the third signal is conveyable to the standard interface via the second and fourth standard physical adapter interfaces and the third signal is conveyable to the consumer electronic device, and the consumer electronic device is configured to use data derived form the third signal to create content which is perceivable to a user, where the content includes at least a partial emulation of the functionality of the electronic media storage device, and the consumer electronic device is configured receive instructions from a user, based on said at least partial emulation, and convey said instructions to said electronic media storage device.

5. A vehicular system comprising:
a vehicle mounted electronic device including a user interface;
a vehicle mounted electronic device interface;
an electronic media storage device including a user interface;
an electronic media storage device physical interface; and
a signal processor;
wherein the signal processor is operationally situated between the vehicle mounted electronic device interface and the electronic media storage device physical interface;
the vehicle mounted electronic device is interconnected with the electronic media storage device, via the vehicle mounted electronic device interface and the electronic media storage device interface;
the vehicle mounted electronic device is configured to emulate at least a portion of the electronic media storage device user interface; and
the electronic media storage device is configured to convey an electronic media signal to said vehicle mounted electronic device.

6. The vehicular system set forth in claim 5, further comprising a signal converter configured to convert a signal from a first form associated with the electronic media storage device to a second form associated with the vehicle mounted electronic device.

7. The vehicular system as set forth in claim 6, wherein the signal converter is encapsulated within the interface.

8. The vehicular system as set forth in claim 6, wherein the signal converter is encapsulated within the wire.

9. The vehicular system as set forth in claim 6, wherein the signal converter is interchangeable.

10. The vehicular system as set forth in claim 9, wherein the signal converter is interchangeable based on the electronic media storage device signal output.

11. The vehicular system as set forth in claim 9, wherein the signal converter is interchangeable based on the electronic media storage device external interface.

12. The vehicular system as set forth in claim 9, further comprising a remote control unit operable to control the electronic media storage device.

13. The vehicular system as set forth in claim 12, wherein the remote control is integrated with a vehicle control system.

14. The vehicular system as set forth in claim 12, wherein the vehicle control system is selected from at least one of the following:
a keyless entry remote control;
an ignition key;
an alarm control; and
a light controller.

15. The vehicular system as set forth in claim 14, wherein the accessible portions of the remote control reflect functionality which is suited to a specific media player.

16. The remote control as set forth in claim 12 wherein there are four switching components on the remote control.

17. The remote control described as set forth in claim 12 wherein there are at least seven switching components on the remote control but the remote functionally limits a user interface to four switching components.

18. The vehicular system set forth in claim 5, wherein the signal processor is configured to processes signal emanating from a remote control unit, and the processed signal is configured to control content delivery from the electronic media storage device.

19. The vehicular system as set forth in claim 6 wherein the vehicle mounted electronic device is selected from at least one of the following:
a visual media player; and
an audio media player.

20. The vehicular system as set forth in claim 6 wherein the electronic media storage device is selected from at least one of:
an MP3 player;
an electronic file player;
an optical file player; and
a magnetic file player.
